(19) United States
(12) Patent Application Publication
(10) Pub. No.: US 2025/0086101 A1
(43) Pub. Date: Mar. 13, 2025

(54) STORAGE DEVICE PERFORMING ASYNCHRONOUS EVENT REPORTING, COMPUTER SYSTEM AND EVENT REPORTING METHOD THEREOF

(71) Applicant: Samsung Electronics Co., Ltd., Suwon-si, Gyeonggi-do (KR)

(72) Inventors: Seokgi HONG, Suwon-si (KR); Seongnam KWON, Suwon-si (KR)

(73) Assignee: Samsung Electronics Co., Ltd., Suwon-si, Gyeonggi-do (KR)

(21) Appl. No.: 18/441,072

(22) Filed: Feb. 14, 2024

(30) Foreign Application Priority Data
Sep. 13, 2023 (KR) 10-2023-0121999

(51) Int. Cl. G06F 12/02

(52) U.S. Cl. CPC G06F 12/0223

(57) ABSTRACT

Disclosed is a storage device configured to receive a read command or a write command from a host device, the storage device comprising, a non-volatile memory device configured to store data, and a storage controller configured to operate at least one virtual machine to control the non-volatile memory device, store a workload threshold of the at least one virtual machine according to settings received from the host device, and send an asynchronous event interrupt to the host device based on the workload threshold, wherein the storage controller is further configured to, store the workload threshold for the at least one virtual machine, monitor read commands or write commands received from the host device to count and update a workload, and determine whether to send the asynchronous event interrupt based on the workload and the workload threshold.

### CROSS-REFERENCE TO RELATED APPLICATIONS

This application claims priority under 35 U.S.C. § 119 to Korean Patent Application No. 10-2023-0121999 filed on Sep. 13, 2023, in the Korean Intellectual Property Office, the disclosures of which are incorporated by reference herein in their entireties.

### BACKGROUND

Example embodiments of the present inventive concepts described herein relate to storage devices, and more particularly, to storage devices configured to perform asynchronous event reporting, computer systems, and event reporting methods thereof.

Recently, multi-tenant technology that runs multiple virtual machines VMs corresponding to users in a cloud environment is being used. These multi-tenant systems require a host or hypervisor to manage multiple virtual machines VMs. The host must use significant resources to monitor the workload of read/write commands of these virtual machines VMs.

In order to monitor workload for each virtual machine VM, the host may periodically send a query requesting workload monitoring results to the storage device. In other words, the host performs polling-based workload monitoring. However, according to this method, as the number of virtual machines VMs installed on the storage device increases, the host overhead also increases. Moreover, as the capacity of storage devices has recently increased rapidly, the number of virtual machines VMs installed per storage device is also rapidly increasing. Therefore, it may be advantageous to provide a storage device workload monitoring technology that can reduce or minimize host overhead.

### SUMMARY

Example embodiments of the present inventive concepts provide a storage device, a method of operating a storage device, and a computer system that can monitor a workload of the storage device to reduce or minimize host overhead.

According to some example embodiments, a storage device may be configured to receive a read command or a write command from a host device, the storage device comprising, a non-volatile memory device configured to store data, and a storage controller configured to operate at least one virtual machine to control the non-volatile memory device, store a workload threshold of the at least one virtual machine according to settings received from the host device, and send an asynchronous event interrupt to the host device based on the workload threshold, wherein the storage controller is further configured to, store the workload threshold for the at least one virtual machine, monitor read commands or write commands received from the host device to count and update a workload, and determine whether to send the asynchronous event interrupt based on the workload and the workload threshold.

According to some example embodiments, an event reporting method for a storage device running a plurality of virtual machines to support multi-tenant services is disclosed, the event reporting method comprising, setting, by a host device, a workload threshold for each of the plurality of virtual machines on the storage device, monitoring a workload of each of the plurality of virtual machines by counting read commands or write commands sent to the storage device, and sending an asynchronous event interrupt for at least one of the plurality of virtual machines regardless of whether a request is received from the host device when the at least one of the plurality of virtual machines exceeds the workload threshold.

According to some example embodiments, a computer system configured to operate in a client environment is disclosed, the computer system comprising a storage device configured to store or read data, and store driving conditions of the computer system in response to a read command, write command, or setting command, and a host device configured to set a count threshold of read commands or write commands of the storage device through the setting command, wherein the storage device includes a non-volatile memory device configured to store the data, and a storage controller configured to store the count threshold according to the setting command, generate a read/write count per unit time by monitoring the read commands or write commands, and send an event interrupt to the host device based on the read/write count and the count threshold.

### BRIEF DESCRIPTION OF THE DRAWINGS

The above and other objects and features of the present inventive concepts will become apparent by describing in detail some example embodiments thereof with reference to the accompanying drawings.

FIG. 1 is a block diagram showing a storage system according to some example embodiments.

FIG. 2 is a block diagram showing the host of FIG. 1 according to some example embodiments.

FIG. 3 is a block diagram illustrating a storage device according to some example embodiments.

FIG. 4 is a block diagram showing another configuration method of the storage controller of FIG. 3 according to some example embodiments.

FIG. 5 is an example block diagram of the non-volatile memory device of FIG. 3 according to some example embodiments.

FIG. 6 shows the setting of the workload threshold WL_TH and the subsequent workload monitoring operation according to some example embodiments.

FIG. 7 is a table showing an example of a set feature command for setting a storage device according to some example embodiments.

FIG. 8 is a flowchart briefly showing the process of setting the workload threshold WL_TH using a set feature command in a storage device according to some example embodiments.

FIG. 9 is a block diagram briefly showing a cloud system according to some example embodiments.

FIG. 10 exemplarily shows the virtual machine settings of the cloud system of FIG. 9, subsequent workload monitoring, and the process of responding when an event occurs according to some example embodiments.

FIG. 11 is a block diagram showing a computer system according to some example embodiments.

FIG. 12 exemplarily shows read/write count RWC monitoring of the computer system of FIG. 11 and response procedures when an event occurs according to some example embodiments.

### DETAILED DESCRIPTION

The present inventive concepts will be described more fully hereinafter with reference to the accompanying drawings, in which some example embodiments of the present inventive concepts are shown. As those skilled in the art would realize, the described example embodiments may be modified in various different ways, all without departing from the spirit and scope of the present inventive concepts. Further, it is to be understood that both the foregoing general description and the following detailed description are exemplary, and it is to be considered that an additional description of the inventive concepts are provided. Reference signs are indicated in detail in some example embodiments of the present inventive concepts, examples of which are indicated in the referenced drawings. Wherever possible, the same reference numbers are used in the description and drawings to refer to the same or like parts.

Accordingly, the drawings and descriptions are to be regarded as illustrative in nature and not restrictive. Like reference numerals designate like elements throughout the specification. The sequence of operations or steps are not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

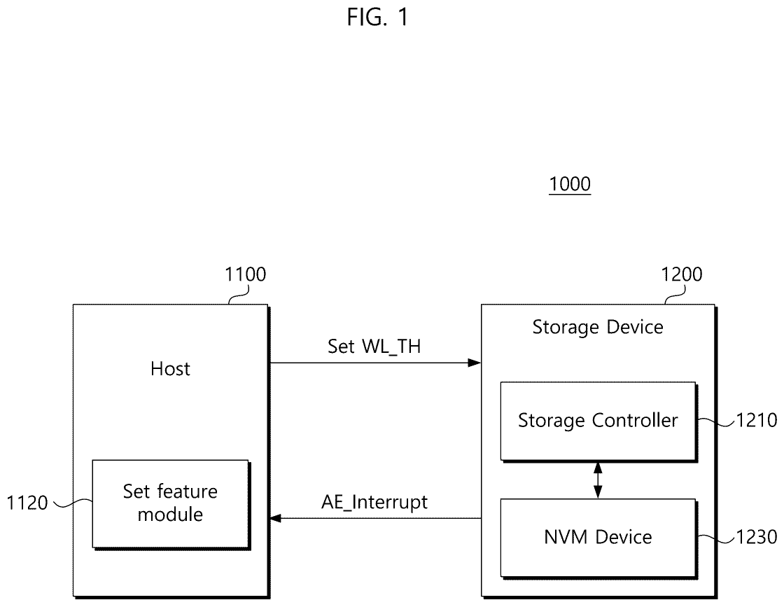

FIG. 1 is a block diagram showing a storage system according to some example embodiments. Referring to FIG. 1, the storage system 1000 may include a host 1100 and a storage device 1200.

The host 1100 may control an overall operation of the storage device 1200. In some example embodiments, the host 1100 may be a host device. The host 1100 may write data to the storage device 1200 or read data written to the storage device 1200. The host 1100 can access the storage device 1200 and set various operating conditions. In some example embodiments, the host 1100 may monitor the workload of the storage device 1200. The host 1100 may reset the storage device 1200 according to the monitoring results or may notify an administrator of the monitoring results.

According to some example embodiments, the workload is, for example, a number of read/write commands per unit time of virtual machines VMs running on the storage device 1200 or the size of read/write data. In some example embodiments, the workload may include at least one of a throughput per unit time of virtual machines VMs, a number of write buffers in use in a storage controller 1210 of the storage device 1200, a write rate, a queue depth, and a write amplification factor (WAF) of the non-volatile memory device 1230. However, the workload according to some example embodiments is not limited thereto and may include various state parameters that may represent the workload. In some example embodiments, workload monitoring results of a virtual machine can be obtained from a virtual machine VM unit, a controller unit, or a combination thereof.

In some example embodiments, the host 1100 may set monitoring conditions for the storage device 1200. In some example embodiments, the host 1100 may include a set feature module 1120. The set feature module 1120 can set monitoring conditions for the storage device 1200 and set a workload threshold WL_TH in the storage device 1200. For example, when the workload of the storage device 1200 reaches the workload threshold WL_TH, the storage device 1200 may transmit or send an event interrupt AE_Interrupt signal without a request (e.g., query) from the host 1100. For example, when the workload of the storage device 1200 reaches the workload threshold WL_TH, an interrupt signal may be transmitted or sent to the host 1100 through asynchronous event reporting. In some example embodiments, the set feature module 1120 can set the event reporting policy of the storage device 1200 using a set feature command or various different control means.

According to some example embodiments, the storage device 1200 may be provided as a storage medium for a server or data center. The storage device 1200 may write data to a non-volatile memory device 1230 or reads data stored in the non-volatile memory device 1230 in response to various data write and read requests. The storage device 1200 may include the storage controller 1210 and the non-volatile memory device 1230.

In some example embodiments, the storage controller 1210 may be configured to control the non-volatile memory device 1230. For example, the storage controller 1210 may write data to the non-volatile memory device 1230 or read data stored in the non-volatile memory device 1230 at the request of the host 1100. To access the non-volatile memory device 1230, the storage controller 1210 may provide, transmit, or send commands, addresses, data, and control signals to the non-volatile memory device 1230.

For example, the storage controller 1210 may include a flash translation layer (FTL) that performs garbage collection. By using the flash translation layer FTL, the potential shortcomings of the non-volatile memory device 1230, such as erase-before-write and mismatch between erase units and write units, can be compensated. In some example embodiments, the flash translation layer (FTL) maps the logical addresses generated by a file system of the host 1100 to physical addresses of the non-volatile memory device 1230. In some example embodiments, the flash translation layer (FTL) may perform wear leveling to manage the lifespan of the non-volatile memory device 1230 and garbage collection to manage data capacity of the non-volatile memory device 1230.

According to some example embodiments, the storage controller 1210 may run a plurality of virtual machines VMs. Each of the plurality of virtual machines VMs may access a memory area allocated in the non-volatile memory device 1230. The storage controller 1210 may generate the event interrupt AE_Interrupt for each of the plurality of virtual machines VMs with reference to the workload threshold WL_TH set by the host 1100. For example, when the workload of the plurality of virtual machines VMs or the entire storage device 1200 reaches the workload threshold WL_TH, the storage controller 1210 transmits or sends the event interrupt AE_Interrupt signal without a request (e.g., a query) from the host 1100 (e.g., without receiving a query request from the host 1100). In some example embodiments, the storage controller 1210 may set the workload threshold WL_TH of the storage device 1200 in response to a set feature command from the host 1100.

In some example embodiments, the nonvolatile memory device 1230 may store data received from the storage controller 1210 or transmit or send the stored data to the storage controller 1210 under the control of the storage controller 1210. The nonvolatile memory device 1230 may include a plurality of memory blocks. Each of the plurality of memory blocks may have a three-dimensional memory structure in which word line layers are stacked in a vertical direction on a substrate. Each of the plurality of memory blocks can be managed by the storage controller 1210 through information for wear leveling, such as an erase count (hereinafter referred to as EC).

According to some example embodiments, the storage device 1200 of the present inventive concepts can set a workload threshold WL_TH by the host 1100. The storage device 1200 may generate an event interrupt AE_Interrupt (e.g., an event interrupt AE_Interrupt signal) in a specific, desired, or preferred unit (VM or memory area unit) with reference to the workload threshold WL_TH set by the host 1100. The storage device 1200 may transmit or send the event interrupt AE_Interrupt when the workload of a specific, desired, or preferred virtual machine VM reaches or exceeds the workload threshold WL_TH without a request from the host 1100. Accordingly, in some example embodiments, the monitoring results of the storage device 1200 can be reported to the host 1100 even without the resources of the host 1100 or increasing the workload of the host 1100 for workload monitoring.

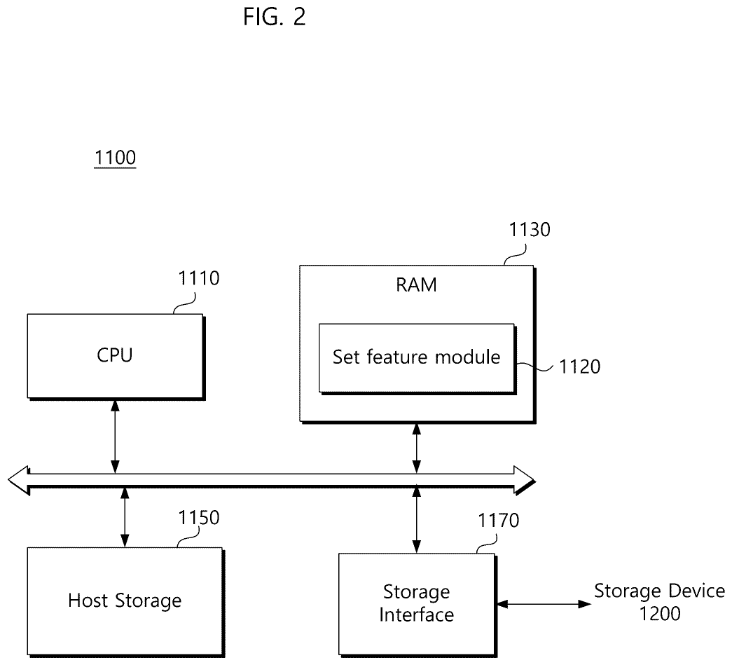

FIG. 2 is a block diagram showing the host of FIG. 1 according to some example embodiments. Referring to FIG. 2, the host 1100 may include a CPU 1110, RAM 1130, host storage 1150, and a storage interface 1170.

In some example embodiments, the host storage 1150 may be a non-transitory computer readable medium and may store a program of instructions. The host storage 1150 may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM). According to some example embodiments, the CPU 1110 can execute software such as various application programs or an operating system OS to control the hardware of the host 1100. For example, the CPU 1110 may execute the set feature module 1120 among various applications loaded into the RAM 1130. The CPU 1110 may set a workload threshold WL_TH of the storage device 1200 according to execution of the set feature module 1120. In some example embodiments, the CPU 1110 may provide various commands, such as a set feature command, a read command, and/or a write command, to the storage device 1200 through the storage interface 1170, but example embodiments are not limited thereto.

Software or data for controlling various configurations of the host 1100 may be loaded into the RAM 1130. Software and data loaded into RAM 1130 may be executed or processed by CPU 1110. According to some example embodiments, various applications, including the set feature module 1120, may be loaded into the RAM 1130. Although not shown, in some example embodiments, an interrupt management module configured to manage a response when receiving the event interrupt AE_Interrupt from the storage device 1200 may be stored in the RAM 1130.

In some example embodiments, the host storage 1150 may store log data or various state data collected from the host 1100. In some example embodiments, when an asynchronous event report such as the event interrupt AE_Interrupt is received from the storage device 1200, status data may be stored in the host storage 1150, and the stored data can be provided to an administrator.

The storage interface 1170 may be configured to provide a communication interface between the host 1100 and the storage device 1200. The storage interface 1170 may apply one of various standard interfaces. For example, the standard interfaces may include ATA (Advanced Technology Attachment), SATA (Serial ATA), e-SATA (external SATA), SCSI (Small Computer Small Interface), SAS (Serial Attached SCSI), PCI (Peripheral component Interconnection), and PCIe (PCI Express), USB (Universal Serial Bus), IEEE 1394, UFS (Universal Flash Storage), eMMC (Embedded Multimedia Card), NVMe, NVMe-of, NVMe-MI, etc.

According to some example embodiments of the host 1100, the host 1100 can set the workload threshold WL_TH in the storage device 1200. For example, by setting the workload threshold WL_TH, the storage device 1200 transmits or sends the event interrupt AE_Interrupt when the workload of a specific, desired, or preferred virtual machine VM exceeds the threshold without a request (e.g., query) from the host 1100. Accordingly, in some example embodiments, it is possible to monitor the workload on the storage device 1200 without resource consumption or overhead of the host 1100.

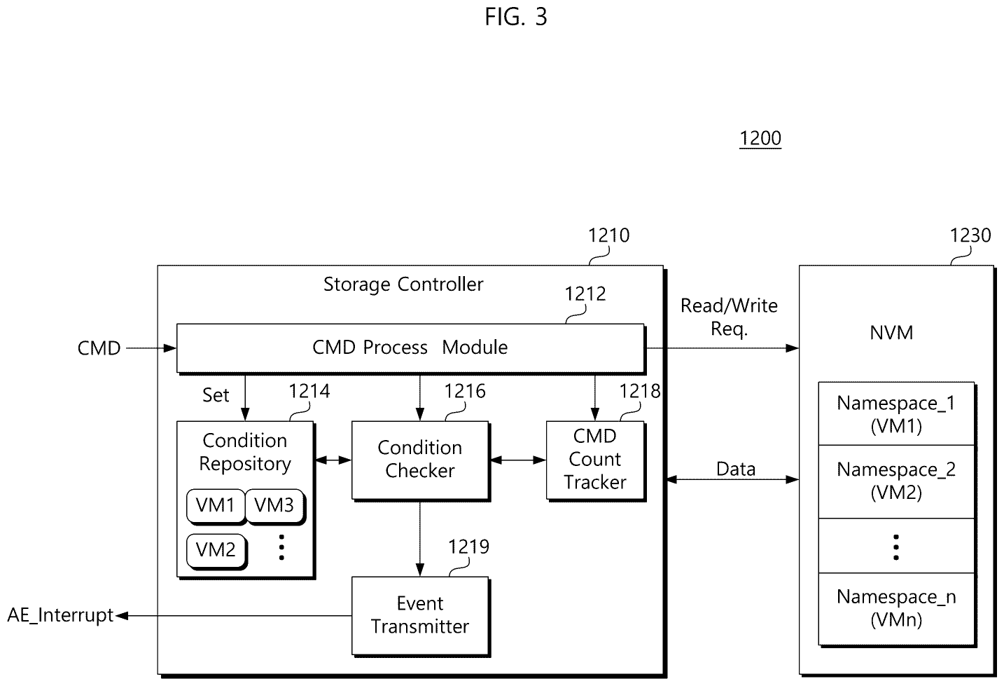

FIG. 3 is a block diagram illustrating a storage device according to some example embodiments. Referring to FIG. 3, the storage device 1200 includes a storage controller 1210 and a non-volatile memory device 1230. In some example embodiments, the storage controller 1210 and the non-volatile memory device 1230 may each be provided as one chip, one package, or one module. Alternatively, in some example embodiments, the storage controller 1210 and the non-volatile memory device 1230 are formed as one chip, one package, or one module, and are used for storage such as embedded memory, memory card, memory stick, solid state drive SSD, etc., but example embodiments are not limited thereto.

In some example embodiments, the storage controller 1210 may be configured to control the non-volatile memory device 1230. For example, the storage controller 1210 may write data to the non-volatile memory device 1230 or read data stored in the non-volatile memory device 1230 at the request of the host 1100 (see, e.g., FIG. 1). In some example embodiments, to access the non-volatile memory device 1230, the storage controller 1210 may receive a read command or a write command. For example, to access the non-volatile memory device 1230, the storage controller 1210 may receive a read command or a write command from the host 1100. In some example embodiments, the storage controller 1210 may receive various different types of commands in addition to the read or write commands. According to some example embodiments, the commands may include an address, data, or control signal.

In some example embodiments, the storage controller 1210 may store monitoring conditions or workload conditions of the storage device 1200 by the host 1100. For example, the host 1100 can set the workload threshold WL_TH in the storage device 1200 through a set feature command or various setting operations. Then, the storage controller 1210 may monitor whether the number or size of read or write commands provided from the host 1100, or the workload generated by command processing reaches the workload threshold WL_TH. For example, if the storage controller 1210 detects that the workload has reached the workload threshold WL_TH, the storage controller 1210 may transmit or send an event interrupt AE_Interrupt without a request (e.g., query) from the host 1100. For example, when the workload of the storage device 1200 reaches the workload threshold WL_TH, the storage controller 1210 may notify the host 1100 of the workload status through an asynchronous event reporting method.

For the above-described workload monitoring and asynchronous event reporting functions, in some example embodiments, the storage controller 1210 may include a command processing module 1212, a condition repository 1214, a condition checker 1216, a command count tracker 1218, and an event transmitter 1219.

The command processing module 1212 may decode the command CMD provided or received from the host 1100 and execute the operation requested by the host 1100 according to the decoding result. For example, when a read command or a write command is provided or received, the command processing module 1212 may perform the read or write operation on the non-volatile memory device 1230. For example, the read or write request may be transmitted or sent to the nonvolatile memory device 1230 to write or read data. In some example embodiments, the command processing module 1212 may also transmit or send the read or write command and address to the command count tracker 1218.

In some example embodiments, the command processing module 1212 may receive a set feature command from the host 1100 to set a workload threshold WL_TH for each virtual machine VM. Upon receiving the set feature command, for example, the command processing module 1212 will decode the command and register the setting value in the condition repository 1214 according to the decoding result. It will be well understood that setting of the condition repository 1214 can be achieved through various control signals or setting commands as well as the set feature command.

In some example embodiments, the condition repository 1214 stores setting information provided by the host 1100. For example, the condition repository 1214 stores the workload threshold WL_TH for each virtual machine VM set using the set feature command sent by the host 1100. For example, when the storage system 1000 provides a multi-tenant service, the workload threshold WL_TH may be a threshold for each user's data usage rate or throughput information per unit time. In some example embodiments, each of the virtual machines (VM1, VM2, VM3, . . . ) may be set to the workload threshold WL_TH corresponding to the plan to which the users have subscribed.

In some example embodiments, the condition checker 1216 compares the workload threshold WL_TH for each virtual machine VM stored in the condition repository 1214 with the command count information of the command count tracker 1218. For example, the condition checker 1216 compares the workload threshold WL_TH of each virtual machine VM with the count information updated by the command count tracker 1218 from read/write commands. In some example embodiments, if it is determined that the command count of at least one virtual machine VM exceeds the workload threshold WL_TH according to the comparison result, the condition checker 1216 transmits or sends the corresponding situation (e.g., situation information) to the event transmitter 1219.

In some example embodiments, the command count tracker 1218 holds and/or stores and updates processing information of various commands CMD provided or sent to the command processing module 1212. For example, the command count tracker 1218 can manage read/write commands processed by the command processing module 1212 for each virtual machine VM. The command count tracker 1218 stores information about the count of read/write commands in the non-volatile memory device 1230 by the first virtual machine VM1, throughput per unit time, size of used data, etc. Hereinafter, information about the number of read/write commands for virtual machines, throughput per unit time, size of used data, etc. will be referred to as count information. In some example embodiments, whenever access to the non-volatile memory device 1230 by the first virtual machine VM1 occurs, the stored count information will be updated. Retention and updating of count information by the command count tracker 1218 may also be performed individually for each of the remaining virtual machines (VM2, VM3, . . . ).

In some example embodiments, the event transmitter 1219 transmits or sends the event interrupt AE_Interrupt to the host 1100 under the control of the condition checker 1216. For example, if it is determined that the count information of at least one virtual machine has reached or exceeded the workload threshold WL_TH, the condition checker 1216 requests the event transmitter 1219 to transmit or send the event interrupt AE_Interrupt. In some example embodiments, the event transmitter 1219 will transmit or send the event interrupt AE_Interrupt including identification information of the corresponding virtual machine VM to the host 1100.

In some example embodiments, the nonvolatile memory device 1230 stores data received from the storage controller 1210 or outputs the stored data to the storage controller 1210 under the control of the storage controller 1210. The nonvolatile memory device 1230 may include a plurality of memory blocks. Each of the plurality of memory blocks may have a three-dimensional memory structure in which word line layers are stacked in a vertical direction on a substrate. In some example embodiments, a memory area may be allocated in units of namespaces (Namespace_1, Namespace_2, . . . , Namespace_n) corresponding to each of the virtual machines (VM1, VM2, VM3, . . . , VMn). The non-volatile memory device 1230 can support a multi-tenant service utilizing virtual machines through memory area allocation in units of namespaces (Namespace_1, Namespace_2, . . . , Namespace_n).

According to some example embodiments of the present inventive concepts, the storage device 1200 may monitor commands or workloads on a virtual machine VM basis in response to condition settings from the host 1100. For example, when the storage device 1200 detects that the count information of a specific, desired, or preferred virtual machine reaches or exceeds the workload threshold WL_TH as the result of monitoring on the virtual machine, the storage device 1200 may transmit or send the event interrupt AE_Interrupt to the host 1100 using the asynchronous event reporting method.

According to some example embodiments, the command processing module 1212, condition repository 1214, condition checker 1216, command count tracker 1218, and event transmitter 1219 included in the storage controller 1210 may be implemented in hardware. For example, the command processing module 1212, condition repository 1214, condition checker 1216, command count tracker 1218, and event transmitter 1219 are formed of functional blocks (Intellectual Property: hereinafter referred to as IP). However, their implementation according to some example embodiments is not limited to hardware methods.

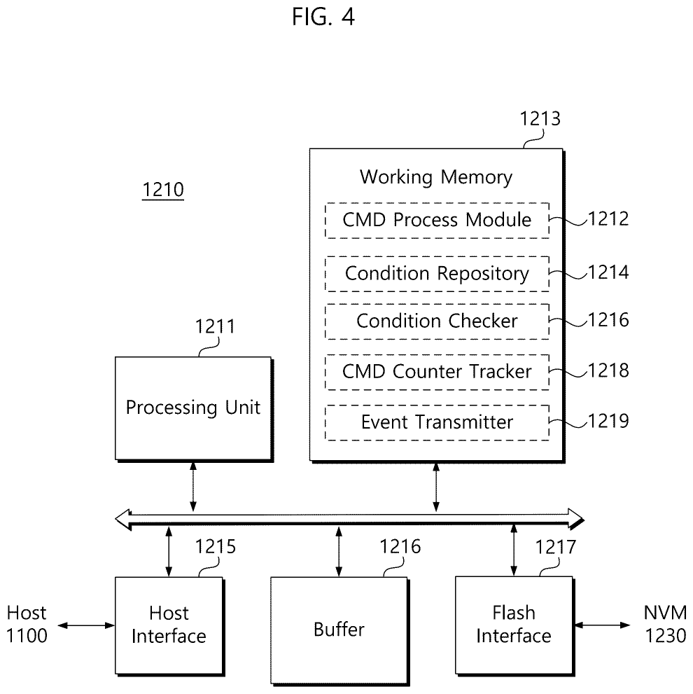

FIG. 4 is a block diagram showing another configuration method of the storage controller of FIG. 3 according to some example embodiments. Referring to FIG. 4, the storage controller 1210 includes a processing unit 1211, a working memory 1213, a host interface 1215, a buffer 1216, and a flash interface 1217. However, it will be well understood that the components of the storage controller 1210 are not limited to the components mentioned above. For example, the storage controller 1210 may further include a read only memory ROM that stores code data required for a booting operation or an error correction code block ECC.

The processing unit 1211 may include a central processing unit or a microprocessor. The processing unit 1211 may run software or firmware for driving the storage controller 1210. In some example embodiments, the processing unit 1211 can drive software modules loaded into the working memory 1213. For example, the processing unit 1211 can run software modules such as a command processing module 1212 loaded in the working memory 1213, a condition repository 1214, a condition checker 1216, a command count tracker 1218, and an event transmitter 1219. In some example embodiments, the processing unit 1211 may execute core functions of the storage device 1200, such as a flash translation layer FTL.

Software (or firmware) or data for controlling the storage controller 1210 is loaded into the working memory 1213. Software and data loaded into the working memory 1213 are driven or processed by the processing unit 1211. In some example embodiments of the present inventive concepts, the working memory 1213 can load a command processing module 1212, a condition repository 1214, a condition checker 1216, a command count tracker 1218, an event transmitter 1219, etc. In some example embodiments, firmware such as a host interface layer HIL or flash translation layer FTL including the functions of the command processing module 1212, condition storage 1214, condition checker 1216, command count tracker 1218, and event transmitter 1219 can be loaded into the working memory 1213. The working memory 1213 may be implemented with, for example, SRAM, but example embodiments are not limited thereto. For example, the working memory 1213 may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a dynamic RAM (DRAM) or a synchronous DRAM (SDRAM).

In some example embodiments, the command processing module 1212 driven by the processing unit 1211 will store the conditions set through the set feature command received from the host 1100 in the condition repository 1214. In some example embodiments, the condition checker 1216 and command count tracker 1218 driven by the processing unit 1211 may compare the workload threshold WL_TH stored in the condition repository 1214 and a count information of the command count tracker 1218 for each virtual machine VM. In some example embodiments, as a result of the comparison, if it is determined that the command count information of at least one virtual machine VM reaches or exceeds the workload threshold WL_TH, the condition checker 1216 may request transmission of the event interrupt AE_Interrupt to the event transmitter 1219. For example, the event transmitter 1219 will transmit or send the event interrupt AE_Interrupt including identification information of the corresponding virtual machine VM to the host 1100.

The command processing module 1212, condition repository 1214, condition checker 1216, command count tracker 1218, and event transmitter 1219 may have substantially the same functions as the hardware configurations of FIG. 3 described above according to some example embodiments. Therefore, detailed descriptions of these will be omitted.

In some example embodiments, the host interface 1215 provides an interface between the host 1100 and the storage controller 1210. The host 1100 and the storage controller 1210 may be connected through one of various standard interfaces. For example, the standard interfaces may include various interface methods such as ATA (Advanced Technology Attachment), SATA (Serial ATA), e-SATA (external SATA), SCSI (Small Computer Small Interface), SAS (Serial Attached SCSI), PCI (Peripheral component Interconnection), and PCIe (PCI Express), USB (Universal Serial Bus), IEEE 1394, UFS (Universal Flash Storage), eMMC (Embedded Multimedia Card), NVMe, NVMe-of, NVMe-MI, etc.

In some example embodiments, the buffer 1216 provides a buffer function for read or write data moving between the host interface 1215 and the flash interface 1217. The buffer 1216 may be implemented with relatively large capacity DRAM considering performance. In some example embodiments, a portion of the buffer 1216 may be provided as a memory area of the condition repository 1214. For example, the setting information or workload threshold WL_TH of each of the virtual machines (VM1, VM2, VM3, . . . ) managed in the condition repository 1214 may be stored in the buffer 1216.

In some example embodiments, the flash interface 1217 provides an interface between the storage controller 1210 and the non-volatile memory device 1230. For example, data processed by the processing unit 1211 is stored in the non-volatile memory device 1230 through the flash interface 1217. According to some example embodiments, data stored in the non-volatile memory device 1230 may be exchanged with the storage controller 1210 through the flash interface 1217.

Configurations of the storage controller 1210 according to some example embodiments have been described. According to the function of the storage controller 1210 of the present inventive concepts, a command processing module 1212 provided as a software module, a condition repository 1214, a condition checker 1216, a command count tracker 1218, and an event transmitter 1219 can be driven. However, example embodiments are not limited thereto, and the command processing module 1212, condition repository 1214, condition checker 1216, command count tracker 1218, and event transmitter 1219 may be composed of a combination of hardware or software.

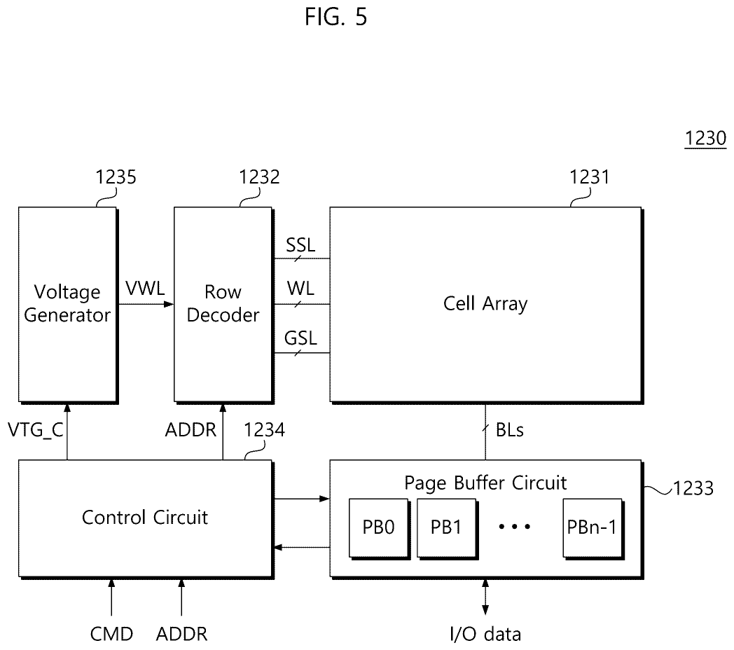

FIG. 5 is an example block diagram of the non-volatile memory device of FIG. 3 according to some example embodiments. Referring to FIG. 5, the non-volatile memory device 1230 may include a cell array 1231, a row decoder 1232, a page buffer circuit 1233, a control logic circuit 1234, and a voltage generator 1235. Although not shown in FIG. 5, in some example embodiments, the nonvolatile memory device 1230 may further include a data input/output circuit or an input/output interface. In some example embodiments, the nonvolatile memory device 1230 may further include components such as column logic, a pre-decoder, a temperature sensor, a command decoder, and an address decoder.

The cell array 1231 may include a plurality of memory blocks. Each of the plurality of memory blocks may include a plurality of memory cells. A plurality of memory blocks may be included in one memory plane, but the present inventive concepts are not limited thereto. In some example embodiments, the cell array 1231 may be connected to the page buffer circuit 1233 through bit lines BLs, row decoder 1232 through word lines WLs, string select lines SSLs, and ground select lines GSLs. In some example embodiments, the cell array 1231 may include a three-dimensional memory cell array.

The row decoder 1232 may select one of the memory blocks of the cell array 1231 in response to an address ADDR received from the control circuit 1234. The row decoder 1232 may select one of the word lines WLs of the selected memory block in response to the address ADDR. The row decoder 1232 may deliver a voltage VWL, received from, e.g., the voltage generator 1235, corresponding to the operation mode to the word line WL of the selected memory block. In some example embodiments, during a program operation, the row decoder 1232 delivers a program voltage and a verification voltage to the selected word line WL and a pass voltage to the unselected word line. In some example embodiments, during a read operation, the row decoder 1232 may deliver a read voltage to the selected word line and a read pass voltage to the unselected word line.

In some example embodiments, the page buffer circuit 1233 may include a plurality of page buffers (PB0 to PBn−1). The plurality of page buffers (PB0 to PBn−1) may be respectively connected to memory cells of the cell array 1231 through a plurality of bit lines BLs. The page buffer circuit 1233 may select at least one bit line among the plurality of bit lines BLs in response to the column address Y-ADDR received from the control circuit 1234. The page buffer circuit 1233 may operate as a write driver or a sense amplifier depending on the operation mode. For example, during a program operation, the page buffer circuit 1233 may apply a bit line voltage corresponding to data to be programmed to the selected bit line. During a read operation, the page buffer circuit 1233 may detect data stored in a memory cell by detecting the current or voltage of the selected bit line.

In some example embodiments, the control logic circuit 1234 can generally control various operations within the non-volatile memory device 1230. The control logic circuit 1234 programs data into the cell array 1231 or reads data from the cell array 1231 in response to a control signal CTRL, a command CMD, and/or an address ADDR. In some example embodiments, various control signals for erasing data stored in the cell array 1231 may be output. For example, the control logic circuit 1234 may output a voltage control signal VTG_C, an address ADDR, etc. In some example embodiments, the control logic circuit 1234 may output control signals for programming multi-bit data according to the received control signal CTRL, command CMD, and/or address ADDR.

The voltage generator 1235 may generate various types of voltages to perform program, read, and erase operations based on the voltage control signal VTG_C. For example, the voltage generator 1235 may generate a program voltage, a read voltage, and a program verification voltage as the word line voltage VWL. For example, the program voltage may be generated using an incremental step pulse program ISPP method.

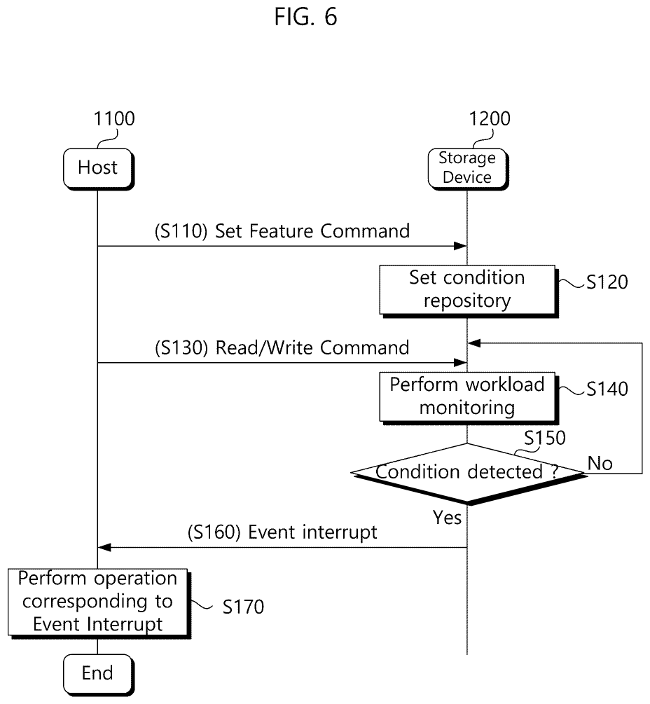

FIG. 6 shows the setting of a workload threshold WL_TH and the subsequent workload monitoring operation performed when initializing or booting a storage device according to some example embodiments. Referring to FIG. 6, the host 1100 may set the workload threshold WL_TH for each virtual machine VM of the condition repository 1214 (see, e.g., FIG. 3) of the storage device 1200 using a set feature command.

In operation S110, the host 1100 transmits or sends a set feature command to the storage device 1200 to set the workload threshold WL_TH. The host 1100 may set the workload threshold WL_TH for each virtual machine VM or memory area. For example, the set feature command can be used to set the workload threshold WL_TH. However, the method of setting the workload threshold WL_TH is not limited to the use of the set feature command. In some example embodiments, the host 1100 may use various control commands or control signals to set the workload threshold WL_TH.

In operation S120, in response to the set feature command, the storage device 1200 stores setting information of the host 1100 in the condition repository 1214 (see, e.g., FIG. 3). The storage device 1200 may store the workload threshold WL_TH for each virtual machine VM set by the host 1100 in the condition repository 1214. For example, when the host 1100 provides a multi-tenant service, the workload threshold WL_TH may be a threshold for each user's data usage rate or throughput information per unit time.

In operation S130, after the workload threshold WL_TH setting for each virtual machine VM is completed, the host 1100 transmits a read command or write command to the storage device 1200.

In operation S140, the storage device 1200 is configured to perform the workload monitoring by, for example, counting input read/write commands with reference to the set workload threshold WL_TH for each virtual machine VM. For example, based on the counted command count information, the throughput or exchanged data size per unit time for each virtual machine VM can be monitored.

In operation S150, the storage device 1200 detects whether the monitoring result of operation S140 corresponds to the set condition. For example, the storage device 1200 compares the workload threshold WL_TH for each virtual machine VM stored in the condition repository 1214 (see, e.g., FIG. 3) with the count information updated in the command count tracker 1218 (see, e.g., FIG. 3). In some example embodiments, the storage device 1200 may determine whether the count information of at least one virtual machine VM exceeds the workload threshold WL_TH according to the comparison result. For example, if the count information of at least one virtual machine VM is detected to exceed the workload threshold WL_TH (‘Yes’ direction) in operation S150, the procedure moves to operation S160. In some example embodiments, if the count information of the virtual machine VM is determined to be less than the workload threshold WL_TH (‘No’ direction) in operation S150, the procedure moves to operation S130 to receive a read/write command and continue monitoring.

In operation S160, the storage device 1200 transmits or sends an event interrupt AE_Interrupt to the host 1100. In some example embodiments, the event interrupt AE_Interrupt may include identification information about the virtual machine VM in which the event occurred.

In operation S170, the host 1100 performs a corresponding operation corresponding to the received event interrupt AE_Interrupt. For example, when providing a multi-tenant service, the host 1100 may perform actions such as changing the rate plan subscribed to by users corresponding to the virtual machine VM. In some example embodiments, the host 1100 may provide information related to the event interrupt AE_Interrupt to the manager.

The functions or operations of the storage device 1200, which performs workload monitoring according to the settings of the host 1100 according to the present inventive concepts and transmits or sends an asynchronous event interrupt according to the results of the monitoring without a request from the host 1100, have been described according to some example embodiments. In some example embodiments, the storage device 1200 may voluntarily transmit the workload status for each virtual machine when a specific condition is reached without a request from the host 1100. Accordingly, it is possible to monitor the workload on the storage device 1200 without resource consumption or overhead of the host 1100.

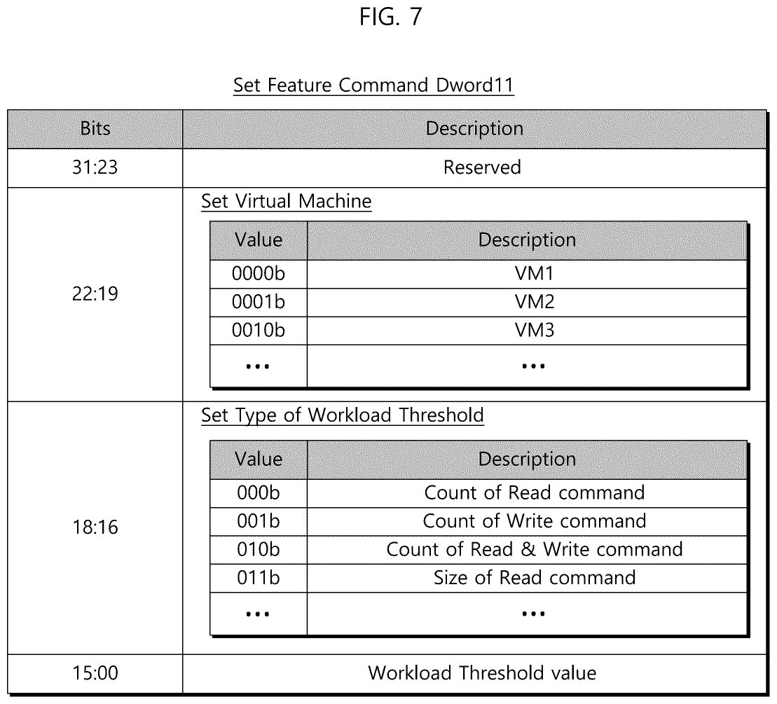

FIG. 7 is a table showing an example of a set feature command for setting a storage device according to some example embodiments. Referring to FIG. 7, a workload threshold WL_TH for each virtual machine VM may be set in a preliminary field (e.g., Dword11) of the set feature command. In some example embodiments, a setting function can be added to reserved fields (19h to 77h) of the feature identifier in the set feature interface. In some example embodiments, ‘Dword11’ is used as a reserved field of the set feature command, but the present inventive concepts are not limited thereto. For example, it will be appreciated that any one of the fields Dword12, Dword13, and Dword15 may be used. ‘Dword’ refers to the 32-bit units of fields that constitute the set feature command. In some example embodiments, the set feature command may be composed of multiple ‘Dwords.’

In some example embodiments, specific, preferred, or desired values of the workload threshold WL_TH can be set in the bits (15:00) of ‘Dword11.’ For example, when setting the count value of a read command, the count value to be set in the 16-bits (15:00) of ‘Dword11’ may be input.

In some example embodiments, the type of workload threshold WL_TH may be provided in the bits (18:16) of ‘Dword11.’ For example, when bits (18:16) are provided as ‘000b’, the storage controller 1210 selects the count value of the read command requested from the host 1100 as the workload value for monitoring. In some example embodiments, when bits (18:16) are provided as ‘001b’, the storage controller 1210 selects the count value of the write command requested from the host 1100 as the workload for monitoring. In some example embodiments, when bits (18:16) are provided as ‘010b’, the storage controller 1210 selects the count value of the read and write commands requested from the host 1100 as the workload for monitoring. In some example embodiments, when bits (18:16) are provided as ‘011b’, the storage controller 1210 selects the data size requested to be read from the host 1100 as the workload for workload monitoring. In some example embodiments, the type of workload threshold WL_TH includes at least one of various values such as the number of write buffers in use by the storage controller 1210, write rate WR, queue depth, and write amplification factor WAF.

In some example embodiments, a virtual machine VM to set the workload threshold WL_TH can be selected in the bits (22:19) of ‘Dword11’. For example, when bits (22:19) are provided as ‘0000b’, ‘0000b’ indicates that the target for which the workload threshold WL_TH is to be set through the set feature command is the first virtual machine VM1. In some example embodiments, when bits (22:19) are provided as ‘0001b’, ‘0001b’ indicates that the target for setting the workload threshold WL_TH through the set feature command is the second virtual machine VM2. The number of virtual machines to be monitored can be set in various ways through the bits (22:19) of ‘Dword11’. For example, by increasing the bits (22:19) of ‘Dword11’, the workload threshold WL_TH of more virtual machines can be set, and the bits (31:23) of ‘Dword11’ can be provided as a reserved area.

In the above, the field values of the set feature command for setting the workload threshold WL_TH for each virtual machine have been described according to some example embodiments. Here, the object for which the workload threshold WL_TH is set has been described on a virtual machine VM basis, but the present inventive concepts are not limited thereto. For example, the workload threshold WL_TH can be set and monitored not only on a virtual machine VM unit, but also on a memory area and storage controller unit. However, it will be well understood that the above described example embodiment is only an example and that in some example embodiments of the present inventive concepts various events and various detailed setting values can be added.

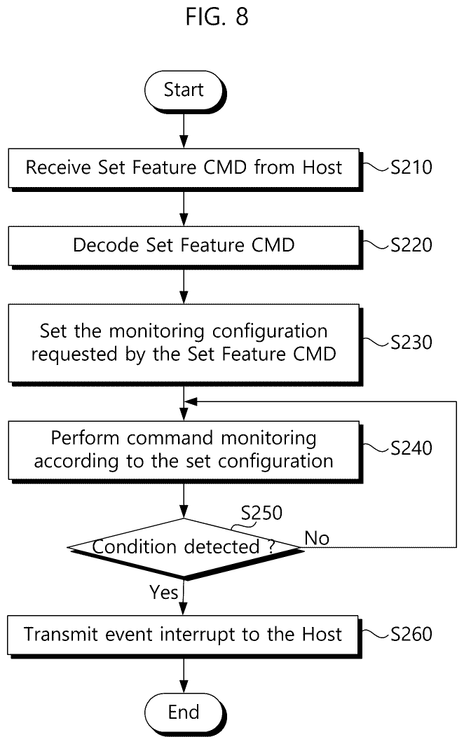

FIG. 8 is a flowchart briefly showing the process of setting the workload threshold WL_TH using a set feature command in a storage device according to some example embodiments. Referring to FIG. 8, in response to receiving a set feature command from the host 1100, the storage device 1200 (see, e.g., FIG. 3) may set a workload threshold WL_TH for each virtual machine VM. In some example embodiments, the storage device 1200 may perform a monitoring operation based on the set workload threshold WL_TH and, in some example embodiments, may transmit or send an event interrupt AE_Interrupt to the host 1100 without a request from the host 1100.

In operation S210, when a set feature command is transmitted or sent from the host 1100, the storage controller 1210 receives the set feature command. The host 1100 can provide, transmit, or send the workload threshold WL_TH and workload type to be monitored for each virtual machine through the set feature command.

In operation S220, the storage controller 1210 decodes the set feature command in the form shown in, for example, FIG. 7. For example, the storage controller 1210 extracts the workload threshold WL_TH, workload type, and virtual machine VM to be applied from the set feature command.

In operation S230, the storage controller 1210 sets parameters for workload monitoring. For example, in operation S230, the storage controller 1210 may set the monitoring configuration requested by the set feature command received from the host 1100. In some example embodiments, the storage controller 1210 may store the workload threshold WL_TH for each virtual machine extracted from the set feature command in the condition repository 1214 (see, e.g., FIG. 3).

In operation S240, the storage controller 1210, for which the workload threshold WL_TH has been set, monitors input commands, for example, the storage controller 1210 may perform command monitoring according to the set configuration. For example, the condition checker 1216 (see, e.g., FIG. 3) obtains information on the number of read/write commands, throughput per unit time, size of data used, data usage rate, etc., for each virtual machine VM counted in the command count tracker 1218. In some example embodiments, the condition checker 1216 compares the obtained count information for each virtual machine with the workload threshold WL_TH for each virtual machine in the condition repository 1214.

In operation S250, the storage controller 1210 performs an operation branch according to the comparison result in operation S240, for example, the storage controller 1210 may determine whether a condition set by the set configuration is detected. For example, the storage controller 1210 determines whether the count information of at least one virtual machine VM exceeds the workload threshold WL_TH. In some example embodiments, if the storage controller 1210 detects or determines that the count information of at least one virtual machine VM exceeds the workload threshold WL_TH (‘Yes’ direction) in operation S250, the procedure moves to operation S260. In some example embodiments, if the storage controller 1210 detects or determines that the count information of the virtual machine VM is less than the workload threshold WL_TH (‘No’ direction) in operation S250, the procedure moves to operation S240 and each virtual machine continues receiving read/write commands and the storage controller 1210 continues monitoring the workload.

In operation S260, the storage controller 1210 transmits or sends the event interrupt AE_Interrupt to the host 1100. In some example embodiments, the event interrupt AE_Interrupt may include identification information about the virtual machine where the event occurred.

Accordingly, the condition setting and event interrupt AE_Interrupt transmission procedures in the storage controller 1210 according to some example embodiments of the present inventive concepts have been briefly described. For example, the storage controller 1210 may set the workload threshold WL_TH for each virtual machine by using a set feature command from the host 1100. In some example embodiments, the storage controller 1210 may transmit or send an event interrupt AE_Interrupt to the host 1100 in an asynchronous manner without a request from the host 1100 according to the set workload threshold WL_TH for each virtual machine. Therefore, it is possible to monitor the workload on the storage device 1200 without causing overhead on the host 1100 that may occur when polling for event checking is used.

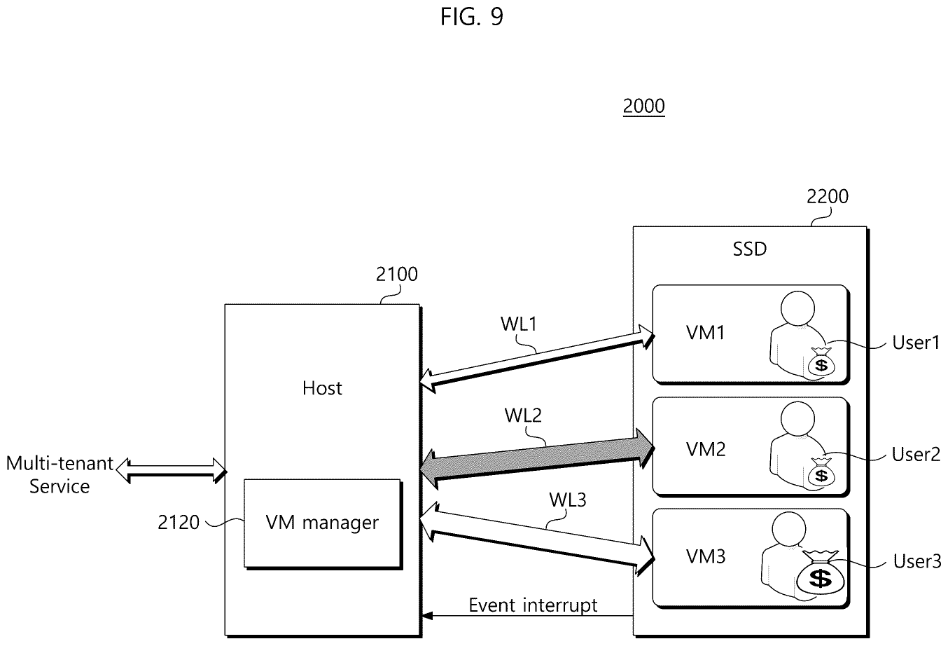

FIG. 9 is a block diagram briefly showing a cloud system according to some example embodiments. Referring to FIG. 9, the cloud system 2000 may be a server that provides multi-tenant services to users. According to some example embodiments, to provide a multi-tenant service, the cloud system 2000 may include a host 2100 and a solid state drive 2200 (hereinafter referred to as SSD).

The host 2100 can provide storage services or streaming services of differentiated quality or capacity to users depending on a rate plan. In some example embodiments, the host 2100 may include a virtual machine manager 2120. The host 2100 may apply different read/write throughput thresholds per unit time to users, who subscribe to a general rate plan (e.g., User1, User2) and to users who sign up for an advanced plan (e.g., User3). For example, the throughput threshold of users who subscribe to the general plan (e.g., User1, User2) may be managed (e.g., by the host 2100) lower than that of the user who subscribes to the advanced plan (e.g., User3). In some example embodiments, the virtual machine manager 2120 may monitor the workload of virtual machines (e.g., VM1, VM2, and VM3) allocated to each user (e.g., User1, User2, User3) on the SSD 2200.

According to some example embodiments, monitoring the workload of virtual machines VM1, VM2 and VM3 may be performed using the asynchronous event reporting method of the SSD 2200 rather than the polling method of the host 1100. For example, the virtual machine manager 2120 sets the workload threshold WL_TH for each virtual machine VM (e.g., VM1, VM2, VM3) in the SSD 2200 according to the rate plan. The workload threshold WL_TH may be a threshold that defines the upper limit of data usage rate for each user (e.g., User1, User2, User3) or throughput per unit time. The SSD 2200 monitors whether the data usage rate or throughput per unit time of each virtual machine VM1, VM2 and VM3 exceeds the workload threshold WL_TH. In some example embodiments, when a virtual machine (e.g., at least one of VM1, VM2, and VM3) whose data usage rate or throughput per unit time exceeds the set workload threshold WL_TH is detected, the SSD 2200 can transmit or send an event interrupt AE_Interrupt without a request from the host 2100. In some example embodiments, the event interrupt AE_Interrupt may be transmitted or sent through asynchronous event reporting or side band.

For example, if the data usage rate or throughput per unit time of User2 using a general plan exceeds the workload threshold WL_TH, the SSD 2200 may report an asynchronous event interrupt to the host 2100. For example, the virtual machine manager 2120 will be able to propose a rate plan upgrade to User2 using the general rate plan.

Accordingly, the advantages of the present inventive concepts in a cloud system 2000 providing multi-tenant services have been explained according to some example embodiments. For example, through asynchronous event interrupt reporting by the SSD 2200, the host 2100 can perform workload monitoring for each virtual machine without overhead.

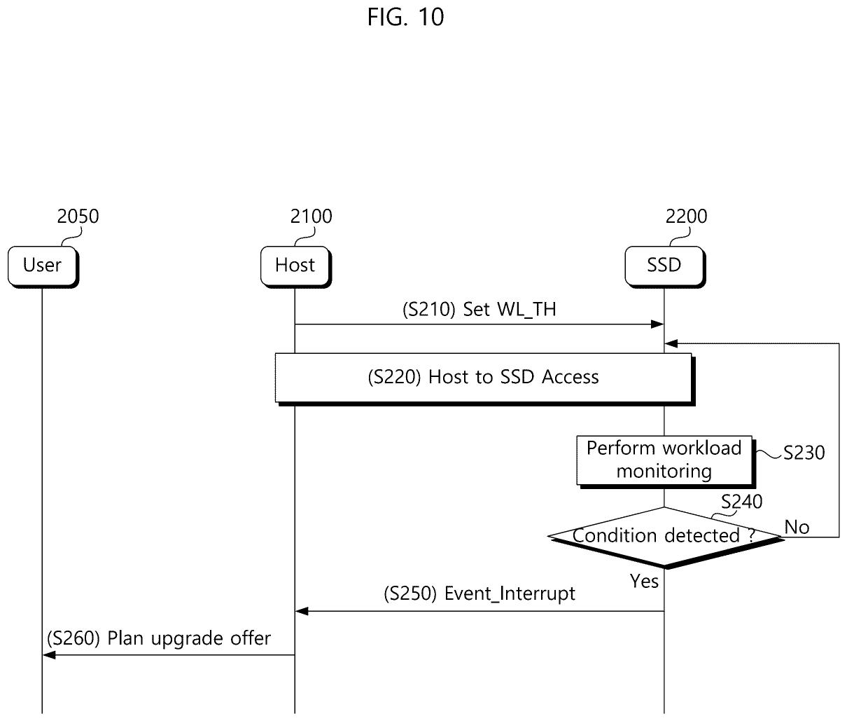

FIG. 10 exemplarily shows the virtual machine settings of the cloud system of FIG. 9, subsequent workload monitoring, and the process of responding when an event occurs according to some example embodiments. Referring to FIG. 10, the host 2100 can set the workload threshold WL_TH of the SSD 2200 and receive a report from the SSD 2200 on whether the workload exceeds the threshold set for each user 2050. In some example embodiments, if a user 2050 is provided with more services than the provided rate plan, the host 2100 may propose a rate plan change or upgrade to the user 2050 in response to an event report Event_Interrupt received from the SSD 2200.

In operation S210, the host 2100 may set a workload threshold WL_TH for each virtual machine VM of the SSD 2200. In some example embodiments, each of the virtual machines may be a unit that manages services for each user 2050. In some example embodiments, the set feature command can be used to set the workload threshold WL_TH. However, the method of setting the workload threshold WL_TH is not limited to the use of the set feature command.

In operation S220, after setting the workload threshold WL_TH, by the host 2100, for each virtual machine VM of the SSD 2200, the host 2100 may transmit or send various read/write commands to the SSD 2200 to provide services to users 2050. For example, access to the SSD 2200 will be performed by the host 2100.

In operation S230, the SSD 2200 counts input read/write commands with reference to the set workload threshold WL_TH for each virtual machine VM. For example, the SSD 2200 may perform the workload monitoring. In some example embodiments, based on the counted command count information, throughput, data usage rate, and exchanged data size per unit time for each virtual machine VM can be monitored.

In operation S240, the SSD 2200 compares the monitoring result of operation S230 with the workload threshold WL_TH, for example, the SSD 2200 may determine whether the condition set by the workload threshold WL_TH is detected. For example, the SSD 2200 determines whether the workload of at least one virtual machine VM exceeds the workload threshold WL_TH according to the comparison result. In some example embodiments, if the workload of at least one virtual machine VM is detected to exceed the workload threshold WL_TH (‘Yes’ direction) in operation S240, the procedure moves to operation S250. In some example embodiments, if the workload of the virtual machine VM is detected to be below the workload threshold WL_TH (‘No’ direction) in operation S240, the procedure returns to operation S220 and the SSD 2200 continues monitoring the workload of the virtual machine VM.

In operation S250, the SSD 2200 transmits or sends an event interrupt AE_Interrupt to the host 2100. In some example embodiments, the event interrupt AE_Interrupt may include identification information about the virtual machine VM where the event occurred.

In operation S260, the host 2100 refers to the received event interrupt AE_Interrupt and suggests a rate plan upgrade to the user 2050.

Accordingly, the operation of the cloud system 2000 that provides multi-tenant services according to the present inventive concepts has been briefly described. For example, the SSD 2200 performs workload monitoring according to the settings of the host 2100 and transmits the asynchronous event interrupt to the host 2100 according to the monitoring result without a request from the host 2100. Therefore, according to the cloud system 2000 of the present inventive concepts, the multi-tenant service can minimize or reduce the overhead of the host 2100.

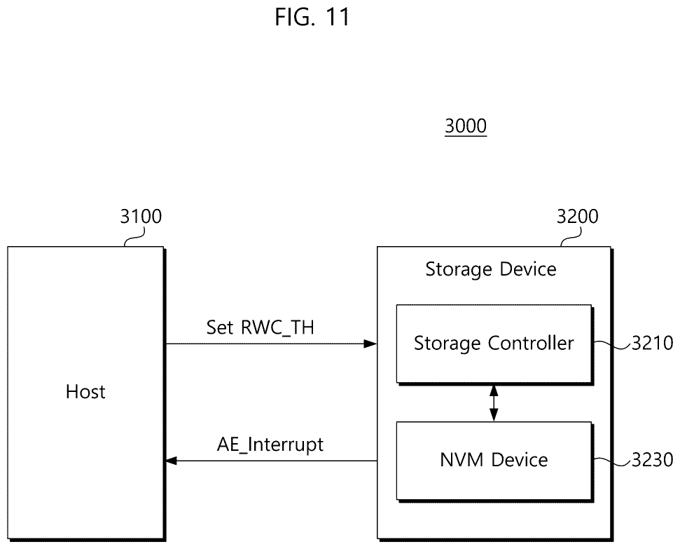

FIG. 11 is a block diagram showing a computer system in a client environment according to some example embodiments. Referring to FIG. 11, the computer system 3000 may include a host 3100 and a storage device 3200.

In some example embodiments, the host 3100 accesses the storage device 3200 and controls overall operations of the storage device 3200. For example, the host 3100 writes data to the storage device 3200 or reads the written data. For example, the host 3100 can access the storage device 3200 and set various operating conditions. In some example embodiments, the host 3100 monitors the read/write count RWC of the storage device 3200 and changes the security policy of the storage device 3200 according to the monitoring results or delivers an event log to a user of the storage device 3200.

In some example embodiments, the host 3100 may set monitoring conditions for the read/write count RWC of the storage device 3200. For example, the host 3100 may set a read/write count threshold RWC_TH in the storage device 3200. For example, the host 3100 may transmit or send a signal including a read/write count threshold RWC_TH to the storage device 3200. In some example embodiments, when the read/write count RWC of the storage device 3200 reaches or exceeds the read/write count threshold RWC_TH, the storage device 3200 may transmit or send an event interrupt AE_Interrupt without a request from the host 3100. For example, when the read/write count RWC of the storage device 3200 reaches or exceeds the read/write count threshold RWC_TH, an asynchronous event interrupt AE_Interrupt may be transmitted or sent to the host 3100. In some example embodiments, the storage device 3200 may transmit or send a signal including the event interrupt AE_Interrupt.

According to some example embodiments, after setting the read/write count threshold RWC_TH, the computer system 3000 may be infected with ransomware by an attacker. In some example embodiments, abnormally high reads/writes (e.g., abnormally high numbers of reads/writes) may occur during the data modification process by ransomware, and the read/write counts may become abnormally high. In some example embodiments, the storage device 3200 may detect an event in which the read/write count increases beyond the read/write count threshold RWC_TH and may deliver, transmit, or send an asynchronous event interrupt AE_Interrupt to the host 3100. In some example embodiments, the host 3100 can recognize the attack as a security attack caused by ransomware and may perform defensive operations such as device locking or delivering an event log to the user.

In some example embodiments, the storage device 3200 may be provided as a storage medium for the computer system 3000. The storage device 3200 may write data to a non-volatile memory device 3230 or read data stored in the non-volatile memory device 3230 in response to various data write and read requests. The storage device 3200 may include a storage controller 3210 and the non-volatile memory device 3230.

In some example embodiments, the storage controller 3210 may be configured to control the non-volatile memory device 3230. For example, the storage controller 3210 may write data to the non-volatile memory device 3230 or read data stored in the non-volatile memory device 3230 at the request of the host 3100. In some example embodiments, to access the non-volatile memory device 3230, the storage controller 3210 may provide commands, addresses, data, and control signals to the non-volatile memory device 3230.

In some example embodiments, the storage controller 3210 stores the read/write count threshold RWC_TH according to the settings of the host 3100, and whenever a read/write operation occurs, the read/write count RWC may be stored and updated. In some example embodiments, if the read/write count RWC per unit time increases above the read/write count threshold RWC_TH, the storage controller 3210 transmits or sends an asynchronous event interrupt AE_Interrupt to the host 3100. For example, when the read/write count RWC per unit time increases above the read/write count threshold RWC_TH, the storage controller 3210 can transmit or send an asynchronous event interrupt AE_Interrupt without a request from the host 3100.

In some example embodiments, the nonvolatile memory device 3230 may store data received from the storage controller 3210 or transmit or send the stored data to the storage controller 3210 under the control of the storage controller 3210. The nonvolatile memory device 3230 may include a plurality of memory blocks.

Here, the read/write count RWC of the storage device 3200 is an example of a workload. For example, the read/write count RWC may include at least one of workload parameters such as the data utilization rate of the storage controller 3210, throughput per unit time, number of write buffers in use, write ratio WR, queue depth, and write amplification factor WAF.

According to the above-described example embodiments, the storage device 3200 of the present inventive concepts can set the read/write count threshold RWC_TH by the host 3100. For example, the storage device 3200 may monitor the read/write count RWC per unit time with reference to the read/write count threshold RWC_TH set by the host 3100 and generate the asynchronous event interrupt AE_Interrupt. Accordingly, in some example embodiments, the storage device 3200 may transmit or send an asynchronous event interrupt AE_Interrupt when abnormal access to the non-volatile memory device 3230 occurs without a request from the host 3100.

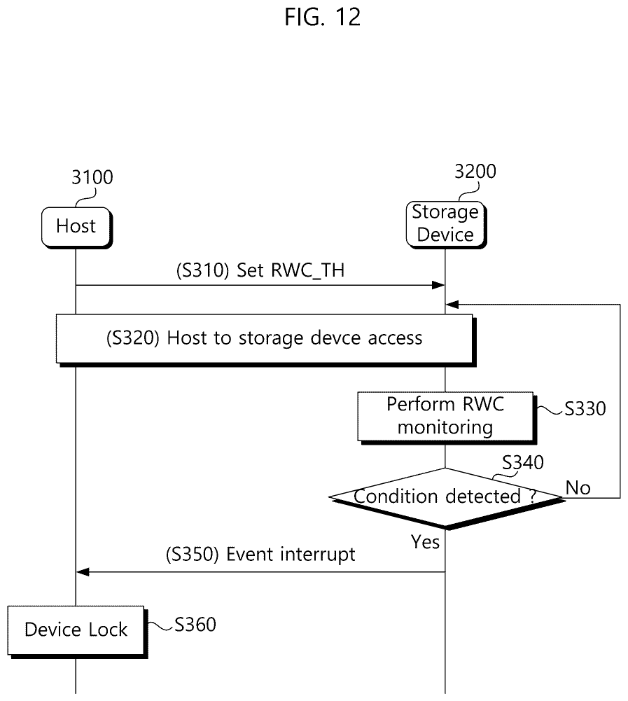

FIG. 12 exemplarily shows read/write count RWC monitoring of the computer system of FIG. 11 and response procedures when an event occurs according to some example embodiments. Referring to FIG. 12, the host 3100 may set the read/write count threshold RWC_TH of the storage device 3200. The storage device 3200 may detect an event in which the read/write count exceeds the read/write count threshold RWC_TH and may transmit or send an asynchronous event interrupt AE_Interrupt to the host 3100.

In operation S310, the host 3100 may set the read/write count threshold RWC_TH of the storage device 3200. In some example embodiments, the read/write count may be the number of read/write commands delivered to the storage device 3200 per unit time, and the read/write count threshold RWC_TH is provided as a reference value for the number of predetermined abnormal read/write commands delivered.

In operation S320, after setting the read/write count threshold RWC_TH of the storage device 3200, the host 3100 may transmit or send various read/write commands to the storage device 3200. For example, access to the storage device 3200 will be performed by the host 3100.

In operation S330, the storage device 3200 counts read/write commands input per unit time with reference to the read/write count threshold RWC_TH. For example, the storage device 3200 may perform read/write count RWC monitoring. In some example embodiments, the storage device 3200 compares the counted read/write count RWC with the read/write count threshold RWC_TH.

In operation S340, the storage device 3200 determines whether the read/write count RWC exceeds the read/write count threshold RWC_TH according to the comparison result, for example, the storage device 3200 may determine whether the condition has been detected. In some example embodiments, if the storage device 3200 detects that the read/write count RWC exceeds the read/write count threshold RWC_TH (‘Yes’ direction) in operation S340, the procedure moves to operation S350. In some example embodiments, if the read/write count RWC is detected to be below the read/write count threshold RWC_TH (‘No’ direction) in operation S340, the procedure returns to operation S320 and the storage device 3200 continues monitoring the read/write count.

In operation S350, the storage device 3200 transmits or sends an event interrupt AE_Interrupt to the host 3100.

In operation S360, the host 3100 may execute a device lock mode as a security response to the computer system 3000 by referring to the received event interrupt AE_Interrupt. For example, the host 3100 may lock the computer system 3000 and/or the storage device 3200 such that further read/write operations cannot or may not be performed. In some example embodiments, the host 3100 may deliver an event log to an administrator or user of the computer system 3000 and request an appropriate security response.

Accordingly, the operation of the computer system 3000 corresponding to the client environment according to the present inventive concepts has been briefly described. For example, the storage device 3200 monitors the read/write count RWC according to the settings of the host 3100, and transmits or sends an asynchronous event interrupt to the host 3100 according to the monitoring result without a request from the host 3100. Therefore, according to the computer system 3000 of the present inventive concepts, the storage device 3200 can detect a sudden increase in read/write count RWC that may occur during a security attack such as ransomware.

The above are some example embodiments for carrying out the present inventive concepts. In addition to the above-described example embodiments, the present inventive concepts may include simple design changes or easily changeable embodiments. In addition, the present inventive concepts include techniques that can be easily modified and implemented using the example embodiments. Therefore, the scope of the present inventive concepts should not be limited to the above-described example embodiments, and should be defined by the claims and equivalents of the claims of the present inventive concepts as well as the claims to be described later.

What is claimed is:

1. A storage device configured to receive a read command or a write command from a host device, the storage device comprising:
a non-volatile memory device configured to store data; and
a storage controller configured to operate at least one virtual machine to control the non-volatile memory device, store a workload threshold of the at least one virtual machine according to settings received from the host device, and send an asynchronous event interrupt to the host device based on the workload threshold,
wherein the storage controller is further configured to,
store the workload threshold for the at least one virtual machine;
monitor read commands or write commands received from the host device to count and update a workload; and
determine whether to send the asynchronous event interrupt based on the workload and the workload threshold.

2. The storage device of claim 1, wherein the workload includes at least one of count information of read/write commands, throughput of read/write operations per unit time, data usage rate, number of write buffers in use of the storage controller, write rate, queue depth, and a write amplification factor (WAF) of the non-volatile memory device.

3. The storage device of claim 1, wherein the storage controller is configured to decode a command received from the host device and store the workload threshold of the at least one virtual machine.

4. The storage device of claim 3, wherein the storage controller is configured to send the asynchronous event interrupt to the host device in response to the determination.

5. The storage device of claim 4, wherein the storage controller further includes processing circuitry and at least one memory.

6. The storage device of claim 3, wherein the command includes at least one of a read command, a write command, and a set feature command for controlling the storage controller.

7. The storage device of claim 6, wherein the set feature command includes a first field specifying the at least one virtual machine, a second field specifying a type of the workload, and a third field specifying a value of the workload threshold.

8. The storage device of claim 1, wherein the at least one virtual machine corresponds to a user of a multi-tenant service, and the workload threshold corresponds to an upper limit of throughput per unit time corresponding to a rate plan to which the user subscribes.

9. An event reporting method for a storage device running a plurality of virtual machines to support multi-tenant services, the event reporting method comprising:
setting, by a host device, a workload threshold for each of the plurality of virtual machines on the storage device;
monitoring a workload of each of the plurality of virtual machines by counting read commands or write commands sent to the storage device; and
sending an asynchronous event interrupt for at least one of the plurality of virtual machines regardless of whether a request is received from the host device when the at least one of the plurality of virtual machines exceeds the workload threshold.

10. The event reporting method of claim 9, wherein the workload includes count information of the read commands or the write commands, data usage rate, throughput of read or write operations per unit time, number of write buffers in use by the storage device, a write rate, queue depth, and write amplification factors (WAF) of the storage device.

11. The event reporting method of claim 9, wherein the setting of the workload threshold comprises:
sending, by the host device, the workload threshold of each of the plurality of virtual machines to the storage device through a set feature command; and
decoding the set feature command to store the workload threshold of each of the plurality of virtual machines in a non-volatile memory.

12. The event reporting method of claim 11, wherein the set feature command includes a first field specifying the plurality of virtual machines, a second field specifying a type of the workload, and a third field specifying a value of the workload threshold.

13. The event reporting method of claim 9, wherein the monitoring of the workload of each of the plurality of virtual machines, comprises:
storing and updating count values of the read command or the write command for each of the plurality of virtual machines; and
determining whether to send the asynchronous event interrupt based on the count values per unit time and the workload thresholds of each of the plurality of virtual machines.

14. The event reporting method of claim 9, wherein the at least one of the plurality of virtual machines corresponds to a user of the multi-tenant service, and the workload threshold corresponds to an upper limit of throughput per unit time corresponding to a rate plan to which the user subscribes.

15. The event reporting method of claim 14, further comprising:
proposing, by the host device, a rate plan change to the user in response to the asynchronous event interrupt.

16. A computer system configured to operate in a client environment, the computer system comprising:
a storage device configured to store or read data, and store driving conditions of the computer system in response to a read command, write command, or setting command; and
a host device configured to set a count threshold of read commands or write commands of the storage device through the setting command,
wherein the storage device includes,
a non-volatile memory device configured to store the data, and
a storage controller configured to store the count threshold according to the setting command, generate a read/write count per unit time by monitoring the read commands or the write commands, and send an event interrupt to the host device based on the read/write count per unit time and the count threshold.

17. The computer system of claim 16, wherein the storage controller is configured to send the event interrupt to the host device when the read/write count per unit time increases beyond the count threshold regardless of whether a request is received from the host device.

18. The computer system of claim 17, wherein the storage controller is configured to determine that the computer system is exposed to a security attack when receiving the event interrupt, and execute a defense measure based on the determination.

19. The computer system of claim 18, wherein the host device is configured to activate a device lockdown mode for the computer system as the defense measure in response to the event interrupt.

20. The computer system of claim 18, wherein the host device is configured to send an event log to an administrator of the computer system in response to the event interrupt.
